(19) United States
(12) Patent Application Publication
(10) Pub. No.: US 2002/0049650 A1
(43) Pub. Date: Apr. 25, 2002

(54) Method and apparatus for providing inventory control of medical objects

(76) Inventor: Albert A. Reff, Madna Del Ray, CA (US)

Correspondence Address: GREENBERG TRAURIG, LLP, 885 Third Avenue, New York, NY, 10022-4834, US

(21) Appl. No.: 09/845,754

(22) Filed: May 1, 2001

Related U.S. Application Data
(63) Continuation of application No. 08/734,246, filed on Oct. 16, 1996, now abandoned.

(51) Int. Cl. G06F 17/60

(52) U.S. Cl. 705/29

(57) ABSTRACT

A method and apparatus for providing inventory management and control of sutures, needles, lap pads, sponges and other medical objects within a sterile operating room environment eliminates the tedious and error-prone manual counting methods, while reducing the handling of sharp objects, such as needles and scalpel blades, by a factor of four or more. In the method and apparatus, one or more types of scanning and counting devices are used to determine the quantity and/or identity of each object that will be taken into the sterile operating room environment. The scanning and counting devices are connected to a computer system which includes inventory control and networking programs to determine if the number and identity of each object initially provided for use in surgery is recovered or accounted for after surgery.

### BACKGROUND OF THE INVENTION

1. Field of the Invention

The present invention relates to inventory control systems, and more particularly to a method and apparatus for providing inventory management and control of sutures, needles, lap pads, sponges and other medical objects within a sterile operating room environment.

2. Description of the Prior Art

Advances in medical technology in recent years have resulted in substantial improvements in patient care, often with reduced hospital stays and related costs. New devices and techniques, such as computer axial tomography (CAT) and balloon angioplasty, have reduced or even eliminated the need for some surgical procedures. In addition, new types of drugs and other treatments have further reduced the need for invasive procedures and long hospital stays.

However, when surgery or other invasive medical procedures are required, the sterile operating room and its accompanying procedures assume a central role in the treatment. Within the operating room environment, large amounts of equipment, supplies and personnel are required for providing treatment. The supplies often include large numbers of sterile objects which are small and difficult to keep track of, particularly during long, complicated and tedious surgical procedures, and are at risk of being lost in the surgical wound with negative medical and liability consequences.

In preparation for a typical surgical procedure, large numbers of these objects such as needles, sutures, scalpel blades, lap pads, 4×4 sponges, cottonoids, peanut sponges, clamps and other instruments must be counted. This counting is usually done by the scrub nurse while the objects are being unpackaged and positioned on trays on the operating room sterile field. As the package for each object is opened, the object is manually counted by the nurse. A second “circulating” nurse verifies the count when the objects are shown to her by the scrub nurse.

During the surgical procedure, these objects are manually accounted for as they are used. For example, used needles and scalpel blades are placed in special open containers that are red in color to indicate biological waste. A manual hand count of these objects is then done at the conclusion of surgery, after which the containers are closed and then discarded. Similar manual counting procedures are used for soft objects such as lap pads and sponges. Reusable objects such as clamps and forceps are counted and placed in other containers or instrument trays for cleaning and resterilization.

Near completion of the surgery, all objects are again manually counted, usually prior to closure of the wound. If this count does not correspond to the initial count, the operating room and wound are searched for the missing object. Eventually, if the object is not found and the count is not reconciled, radiological studies are used to determine whether the missing object has been left in the wound. If so, the wound is reexplored; if not, the original count is assumed to have been in error.

In addition, in the traditional operating room, a sharp object such as a suture needle is handled many times. The circulating nurse opens the outer wrapper of a suture package and flips the sterile inner package onto a sterile back table or Mayo stand while a scrub nurse watches. The scrub nurse then opens the sterile inner package, grasps the suture needle with a needle holder, pulls the coiled needle and suture from the package, and may then hand the needle holder to the surgeon or place it on the sterile Mayo stand for later use.

When requested by the surgeon, the loaded needle holder is handed to the surgeon by the scrub nurse. The surgeon passes the needle through the tissues to be sutured, knots the ends of the suture, cuts the suture at the knot with a scissor, and hands the needle holder containing the used needle back to the scrub nurse. The scrub nurse places the used needle on a plastic or magnetic needle tray for subsequent manual counting. Toward the end of the surgery, the scrub nurse manually counts all of the used needles at least twice with the circulating nurse observing the counting. If the counts are correct, at the end of the surgery the scrub nurse discards the used needles into a red sharp disposal container.

Accordingly, there is a need for a method and apparatus for providing a more reliable and easier inventory control of medical objects within the sterile operating room environment, which eliminates the error-prone and time consuming manual counting methods, which can be used with existing medical inventory control systems, and which reduces the need for frequent handling of sharp objects, such as needles and scalpel blades, by medical personnel.

### SUMMARY OF THE INVENTION

The preferred embodiments of the present invention are directed to a method and apparatus for providing inventory control of medical objects within a sterile operating room environment. The method and apparatus of the preferred embodiments of the present invention eliminate the disadvantages of conventional time consuming and error-prone manual counting methods, while reducing the frequency of handling of sharp objects, such as needles and scalpel blades, by a factor of four or more.

A goal of the preferred embodiments of the present invention is to save time by eliminating the tedious manual counting procedures now in use for counting sutures, needles, scalpel blades, sponges, lap pads and other instruments and objects. Another goal is to substantially reduce the amount of handling of sharp instruments and objects which have been contaminated by blood or other biological fluids. Overall, the preferred embodiments of the present invention increase the efficiency of the inventory control procedures within the operating room environment.

The preferred embodiments of the present invention preferably use laser or other optical, magnetic, ultrasonic or radiological scanning technologies to manage the inventory of critical objects in the operating room environment. Specifically, one or more types of scanning and counting devices are used to determine the quantity and/or identity of each object that will be taken into the sterile operating room environment. Of particular concern are objects which are at risk of being lost in wounds, such as sponges, lap pads, pledgets, peanut sponges, cottonoids, needles and clamps.

According to the preferred embodiments of the present invention, an initial, preoperative count for such critical operating room objects is performed by preoperative scanning of such objects by the circulating nurse. In this scanning process, the circulating nurse preferably uses one or more of the scanning and counting devices mentioned above.

During and after the operation, many of the critical objects are scanned and then discarded. Other critical objects are placed on a tray or other suitable surface for postoperative scanning. Intraoperative and postoperative scanning of all initially scanned objects is automatically reconciled at the end of the surgical procedure, instead of being performed manually by several surgical personnel.

In a first preferred embodiment of the present invention, a sterile self-contained disposable sharp object container is fitted with a counter/LED display mechanism. The counter/LED display mechanism is preferably mounted onto the collar of the disposable container. During and after surgery, used objects are placed in the disposable container by passing them through the counter/LED display mechanism which maintains a running count of the number of objects placed in the container. At the end of the surgical procedure, the counter/LED mechanism is removed from the disposable container and the disposable container is then sealed and discarded in the usual manner as contaminated medical waste.

Power to the counter/LED mechanism may be provided via a sterile disposable lead such as used with a Bovie cord or may be provided by an internal power source such as a battery.

A second preferred embodiment of the present invention includes an apparatus capable of determining and maintaining both a running count and the specific identity of each object placed in the disposable container. This capability requires that each surgical object be marked with an identifying code, such as a bar code, and is most useful for keeping track of hard, sharp objects including needles and scalpel blades and other hardware. This apparatus provides more complete inventory control data, as opposed to the generic counting provided in the first preferred embodiment.

For example, the inventory control of various sizes and/or types of screws, bolts, plates and other hardware used in orthopedic surgery may be improved by coding and scanning each item prior to surgery. This scanned data can be transmitted directly to the hospital inventory control system or to the appropriate product vendor for automatic reordering.

In a third preferred embodiment of the present invention, a hand held laser scanner provides the basic method of initial object counting, both inside or outside the sterile operating room environment. Needles, scalpel blades, sponges, pads and other objects are preferably lined up on a sterile magnetic receptacle or tray and the number of each type of object is scanned into the system. This preferred embodiment can be used for both generic and specific counting, depending on the type of object and coding system.

A fourth preferred embodiment of the present invention includes a fixed scanning device having a slot through which objects may be passed through for pre-operative or post-operative scanning. Individual objects, such as packaged sutures or scalpel blades, are passed through the slot for pre-operative counting. Similarly, groups of objects, such as lap pads, sponges or cottonoids may be fixed to a reusable holder and passed through the slot as a group for pre-operative counting. The same disposable holders for used lap pads, sponges or cottonoids likewise facilitate post-operative scanning by passage through the slot.

In a fifth preferred embodiment of the invention, a scale (not shown) for determining the weight of blood or other fluid loss in sponges and lap pads occurring during the surgical procedure may be included. This data can then be made available to a conventional anesthesia or hemodynamic data system under the supervision of the anesthesiologist.

Each preferred embodiment of the present invention preferably further includes a computer-based data collection system. The output from each counting or scanning device is transmitted to the data collection system for inventory management and control. The data collection system, which preferably comprises a conventional database management program, helps to insure that all objects which enter the sterile operating room environment are accounted for in the initial and final counts. The data collection system also minimizes the handling of sharp objects by eliminating most of the manual interim counts. Accordingly, the number of accidental cuts or sticks and the time spent searching for lost objects is significantly reduced. Moreover, the costs involved in extra anesthesia and operating room time can also be reduced, along with the time and expense of additional radiological studies used to determine the presence or absence of objects left in the wound.

The preferred embodiments of the present invention further include a method for counting and keeping track of all medical objects which enter the sterile operating environment. A method according to a preferred embodiment of the present invention provides a fully integrated approach to the inventory management of medical objects within the operating room.

Further features and advantages of the present invention will be appreciated by a review of the following detailed description of the preferred embodiments taken in conjunction with the following drawings.

### BRIEF DESCRIPTION OF THE DRAWINGS

The present invention may be best understood by referring to the following detailed description of the preferred embodiments and the accompanying drawings, wherein like numerals denote like elements and in which:

FIG. 1 is a functional block diagram of an apparatus 100 for providing inventory control of medical objects, constructed in accordance with a preferred embodiment of the present invention;

FIG. 2 is a plan view of a conventional operating room 200, showing specific sterile and non-sterile fields that are relevant to the preferred embodiments of the present invention;

FIG. 3 is a perspective view of a device 300 according to a preferred embodiment of the present invention for counting and storing sharp medical objects such as needles and scalpel blades;

FIG. 4 is a side elevation of device 400 according to a preferred embodiment of the present invention, showing a sterile disposable receptacle for capturing medical objects;

FIG. 5 is a perspective view of a device 500 according to a preferred embodiment of the present invention for counting medical objects which are marked with a bar code or other identifying marking;

FIG. 6 shows the packaging for a conventional medical suture 600 which includes a bar code for use with the device of FIG. 5;

FIG. 7 is a top view of a magnetic storage strip 700 for holding used needles and sutures for post-operative counting in accordance with the preferred embodiments of the present invention;

FIG. 8 is a top view of a magnetic storage strip 800 for holding used scalpel blades for post-operative counting in accordance with the preferred embodiments of the present invention;

FIG. 9 is a top view of a storage strip 810 for holding used soft medical objects such as lap pads or sponges;

FIG. 10 is a side view of storage strip 810 of FIG. 9;

FIG. 11 is a flowchart 900 showing the steps of a method according to a preferred embodiment of the present invention for providing inventory control of medical objects; and

FIGS. 12a-c show flowcharts of the steps of a method for reconciling the pre-operative and post-operative counts of the method of FIG. 9.

### DETAILED DESCRIPTION OF PREFERRED EMBODIMENTS

The following exemplary discussion focuses on a method and apparatus for providing inventory control of medical objects within a sterile operating room environment. The method and apparatus of the preferred embodiments of the present invention eliminate the errors prevalent in manual counting methods that are currently in use, while simultaneously reducing the frequency of handling of sharp objects, such as needles and scalpel blades, by a factor of four or more.

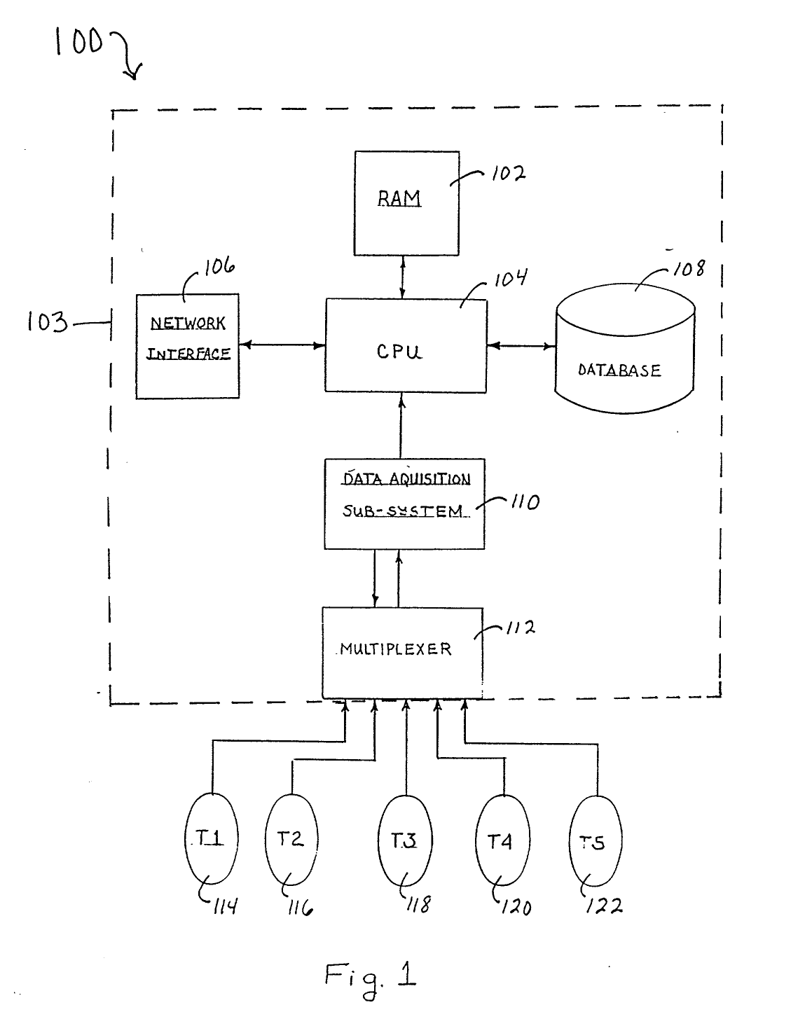

Referring to FIG. 1, a functional block diagram of an apparatus 100 for providing inventory control of medical objects, constructed in accordance with a preferred embodiment of the present invention, is shown. In the preferred embodiment, apparatus 100 preferably includes a computer system 103 comprising a central processing unit (CPU) 104, a random access memory (RAM) 102, a software database 108 and a network interface 106. CPU 104 and RAM 102 are used to process and temporarily store computer program instructions for counting and tracking medical objects within the sterile operating room environment. Database 108 preferably comprises a conventional database management program such as Microsoft Access (available from Microsoft Corporation, One Microsoft Way, Redmond, Wash. 98006), which provides non-volatile storage and management of the data relating to the counting and tracking of the medical objects. The storage provided by database 108 is called “nonvolatile” because the database is maintained even after the power to computer system 103 has been removed.

Network interface 106 provides the ability to connect computer system 103 to other computer and information systems through a local or wide area network, for example. This connection ability allows apparatus 100 to form a part of a larger medical inventory control and management system. For example, apparatus 100 may be connected to a conventional materials requisition and planning (MRP) system so that the numbers and types of objects may be closely tracked and automatically re-ordered as necessary.

Apparatus 100 further includes a data acquisition sub-system 110 and multiplexer 112 for receiving and processing data received from one or more transducers 114-122. The data acquisition sub-system 110 and multiplexer 112 may preferably comprise known electronic hardware and software capable of receiving, processing and transmitting signals to the CPU 104 as is known in similar input/output interface and signal processing devices.

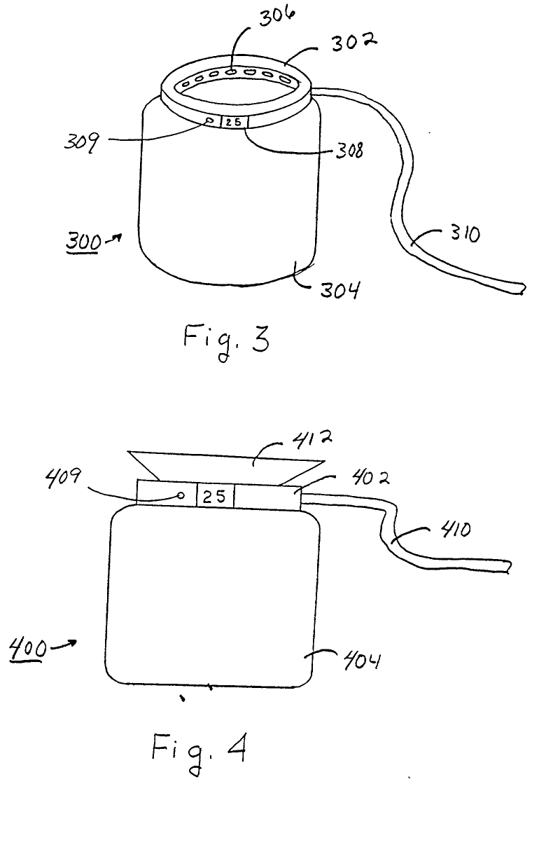

In the preferred embodiment, transducers 114-122 may include optical, magnetic, ultrasonic or radiological devices or other suitable data obtaining devices for scanning each medical object and generating an electrical signal which encodes the identity of each scanned object. Transducers 114-122 may be embodied in known handheld scanning devices such as a laser scanning gun. Alternatively, the transducers may be embodied in the scanning devices shown in FIGS. 3-5 or other suitable known scanning devices. Each electrical signal generated by the transducers 114-122 is communicated to multiplexer 112 which, in turn, transmits each electrical signal to data acquisition sub-system 110 where the signals are preferably converted to digital form and transferred to computer system 103 for decoding and storage in database 108.

A typical operation of apparatus 100 involves the scanning of critical surgical objects including preoperative, intraoperative and postoperative scanning using transducers 114-122. The signals generated by transducers 114-122 preferably include either a simple count information (one object scanned) or also include identification information for each object scanned. Each of the signals will include information regarding whether the object scanned is part of a pre-operative, intraoperative or post-operative count process. The signals generated by transducers 114-122 are transmitted to data acquisition subsystem 110 via multiplexer 112. After the signals are stored in the database 108 as described above, the data resulting from the signals is ready for use. As will be described in the following paragraphs, upon completion of a surgical procedure, computer system 103, using appropriate software stored therein, will determine if the initial object count and the postoperative object count match, thereby eliminating any manual counting or matching of preoperative and postoperative counts. In addition, as described below, computer system 103 may identify the missing object or objects after determining that the initial object count and postoperative object count do not match.

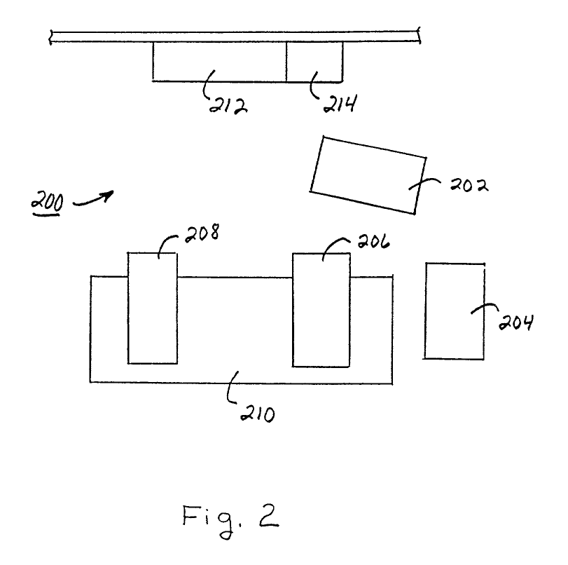

Referring now to FIG. 2, a plan view of a conventional operating room 200, showing specific sterile and non-sterile fields that are relevant to the preferred embodiments of the present invention is shown. The sterile fields of operating room 200 include sterile trays 202 and 204, Mayo stands 206 and 208, and operating table 210. The non-sterile fields of operating room 200 may include storage cabinet 212 and desk 214. In fact, a large portion of operating room 200 is not required to be sterile.

Any objects which come in contact with any of sterile fields 202-210 must first be sterilized. For example, needles, sutures, scalpel blades, lap pads, sponges and cottonoids are typically provided in sterile packages which are opened using procedures which maintain the sterility. Similarly, all instruments, electrical cords, sheets and drapes are also sterilized prior to being introduced into any of the sterile fields.

FIG. 3 shows a perspective view of a first preferred embodiment of a device 300 for counting and storing sharp medical objects such as needles and scalpel blades for use with apparatus 100 shown in FIG. 1. Device 300 includes a self-contained disposable sharp object container 304 that is preferably fitted with a visible counter/LED display mechanism 302. Container 304 preferably comprises a conventional red plastic container which is used to dispose of biologically contaminated waste. Counter/LED display mechanism 302 preferably comprises an array of sensors 306 provided within a circular collar and an internal counter (not shown) for counting the objects sensed by the sensors 306. The sensors 306 correspond to one or more transducers 114-122 of FIG. 1. The internal counter in counter/LED display mechanism 302 is preferably connected to multiplexer 112 and data acquisition subsystem 110 via a sterile disposable electrical cord 310 or other suitable signal transmitting device such as an infrared connector to provide object count information to computer system 103. Counter/LED display mechanism 302 may preferably be powered via an internal power source such as a battery or may be connected to an external power source via a sterile electrical cord not shown.

Counter/LED display mechanism 302 also preferably includes a display preferably including a light emitting diode (LED) display 308 for indicating a number of discarded objects. Counter/LED display mechanism 302 also preferably includes a reset button 309 for resetting the count indicated on display 308.

Counter/LED display mechanism 302 is preferably mounted onto the collar of disposable container 304. During and after surgery, used sharp objects, such as needles and scalpel blades, are placed in disposable container 304 by dropping them through counter/LED display mechanism 302. Sensors 306, corresponding to one or more transducers 114-122, sense each object being dropped into container 304. Sensors 306 are electrically connected to counter/LED display mechanism 302 such that the internal counter in counter/LED display mechanism 302 counts each object sensed by sensors 302 and maintains a running count of the number of objects placed in container 304. Additionally, counter/LED display mechanism 302 may contain an indicator device (not shown) such as a visual indicator in the form of a flashing light, for example, or an audible indicator in the form of a sound generating device to generate an audible “beep” or similar tone each time an object is dropped into disposable container 304.

During the surgical procedure, counter/LED display mechanism 302 maintains a count of each object discarded into container 304 and transmits this count as a post-operative count to computer system 103 via multiplexer 112 and data acquisition subsystem 110. At the end of the surgical procedure counter/LED mechanism 302 is removed from disposable container 304. Then disposable container is sealed and discarded according to established procedures for the disposal of biologically contaminated materials.

It is not necessary that counter/LED display mechanism 302 be connected to computer system 103. Counter/LED display mechanism 302 may be independent of the computer system 103 and used by personnel in the operating room to compare the count of initial objects stored in computer system 103 with a final count displayed on counter/LED display mechanism 302.

Continuing with FIG. 4, a side elevation of device 400 for counting and storing sharp medical objects is shown. Device 400 is similar to device 300 shown in FIG. 3 and is preferably connected to computer system 103 via a sterile cable 410. Device 400 also includes a reset button 409 and a counter/LED display mechanism 402. In FIG. 4, counter/LED display mechanism 402 includes a sterile disposable receptacle 412 for guiding objects through the collar of counter/LED display mechanism 402 and into disposable container 404. In addition to providing an effectively larger opening for container 404, sterile receptacle 412 further reduces the risk of contamination of surgical instruments, such as needle holders or scalpel handles, with which it may come in contact.

Device 400 provides both a running count along with the specific identity of each object placed in disposable container 404. To do so, sensors (not shown) similar to sensors 306 in FIG. 3 or transducers 114-122 preferably comprise known data or optical character reading devices such as laser bar code readers or optical scanners which are capable of reading bar codes or other identification indicia contained on the objects to be counted and identified. Obviously, in order for the sensors or transducers 114-122 of device 400 to identify each object, each object must be marked with an identifying code, such as a bar code. Device 400 having object identification ability is most useful for hard, sharp objects including needles and scalpel blades and other hardware. Device 400 can thus provide more complete inventory control data, as opposed to generic counting.

For example, the inventory control of various sizes and/or types of needles, screws, bolts, plates and other hardware used in orthopedic surgery may be improved by coding and scanning each item prior to surgery. This scanned data can be transmitted directly to the hospital inventory control system or to the appropriate product vendor for automatic reordering.

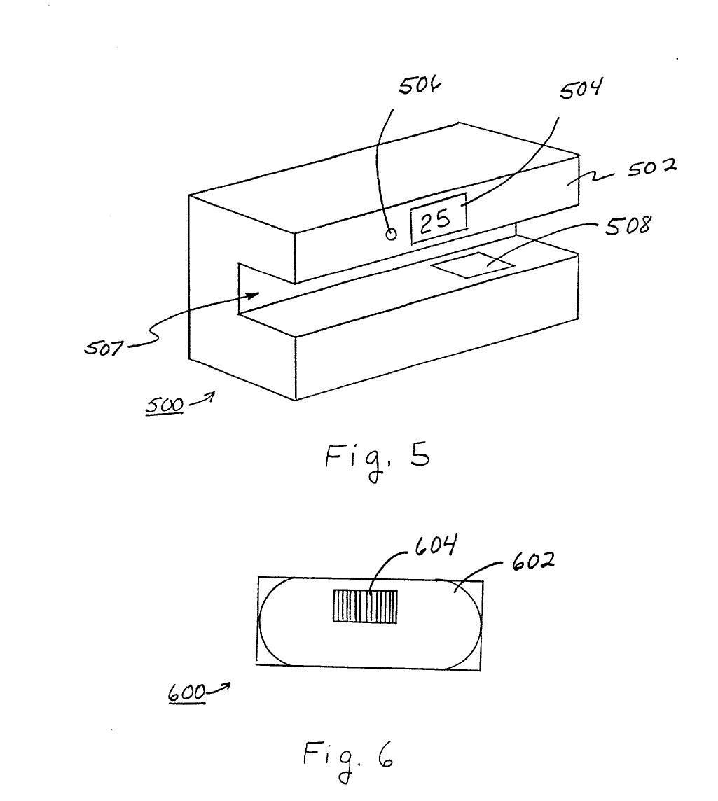

Referring to FIG. 5, a perspective view of a second preferred embodiment of a device 500 for specifically counting medical objects which are marked with a bar code or other identifying nomenclature is shown. Scanning device 500 has a slot 507 having a sensing device 508 through which objects may be passed through for scanning. Packaged objects, such as sutures or scalpel blades, are passed through slot 507 for counting. Alternatively, groups of objects, such as lap pads, sponges or cottonoids may be fixed to a holder or rack and passed through slot 507 as a group for counting.

Scanning device 500 also preferably includes an LED display 504 for displaying the total number of objects counted, along with a button 506 for resetting LED display 504. Additionally, scanning device 500 may generate a visual indicator or an audible indicator such as a beep or similar tone each time an object is passed through slot 507 and detected by sensing device 508, similar to the alarm system described with reference to the preferred embodiment shown in FIG. 3.

FIG. 6 shows a typical packaged medical object 600, such as a needle or suture, which may be counted using scanning device 500 or device 400 of FIG. 4. In the preferred embodiment, packaged object 602 is imprinted with a bar code 604 or other identifying nomenclature which may be scanned. Package 602 is passed through slot 507 where bar code 604 is read by sensor 508, and a visual signal or an audible beep may be generated when bar code 604 has been successfully read.

Alternatively, a conventional hand-held laser scanner (not shown) may provide the basic method of object scanning, both inside or outside the sterile operating room environment. Packages of needles, scalpel blades, sponges, pads and other objects are lined up on a sterile magnetic tray and the number of each type of object is scanned into the system. This preferred embodiment can be used for both generic and specific counting, depending on the type of object and package coding system. The conventional hand-held scanner can be connected to computer system 103 for transmitting count information to computer system 103. Alternatively, the conventional hand-held scanner can store count information locally on a computer disk or other data storage device, and then the computer disk or other data storage device can interface with computer system 103 to transfer the count information thereto.

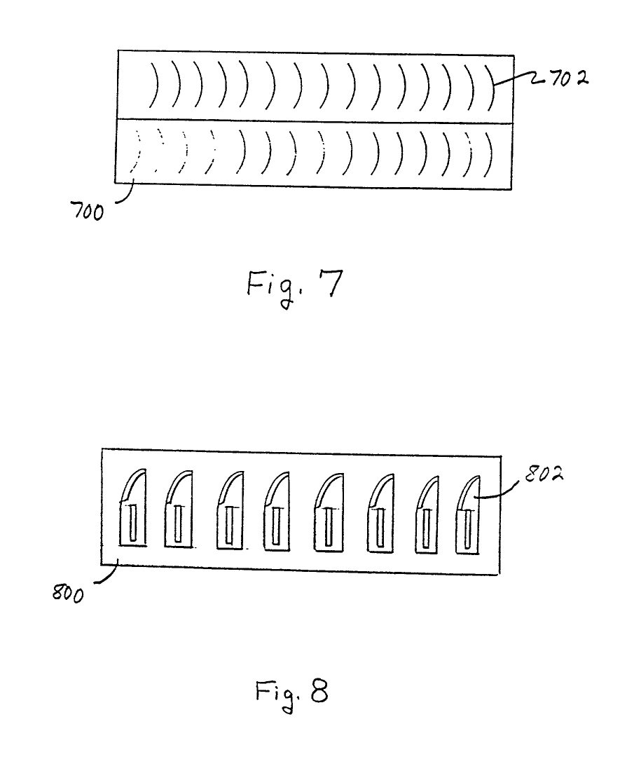

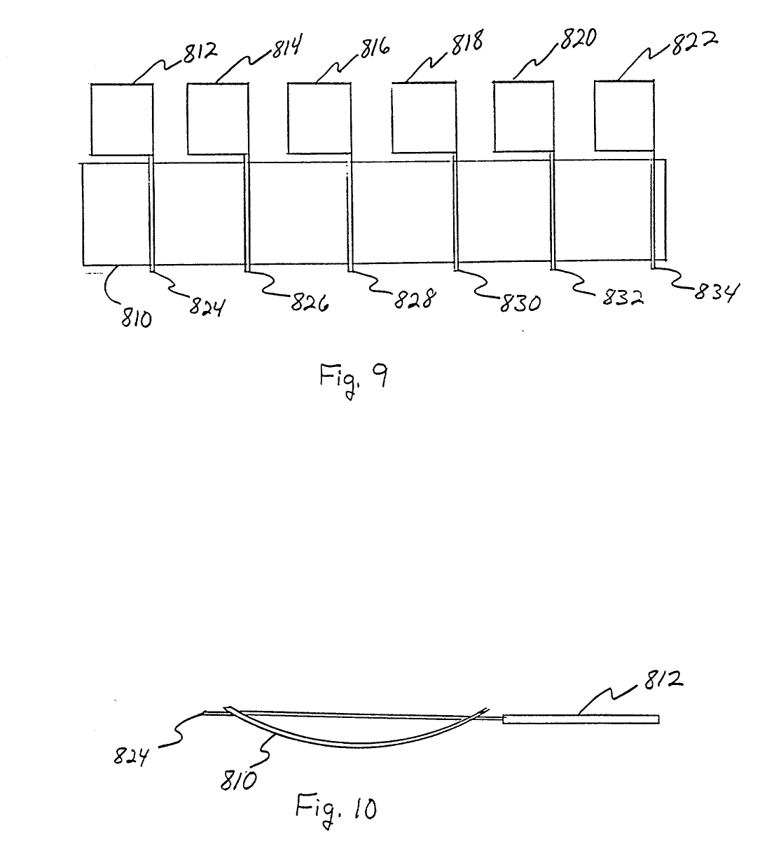

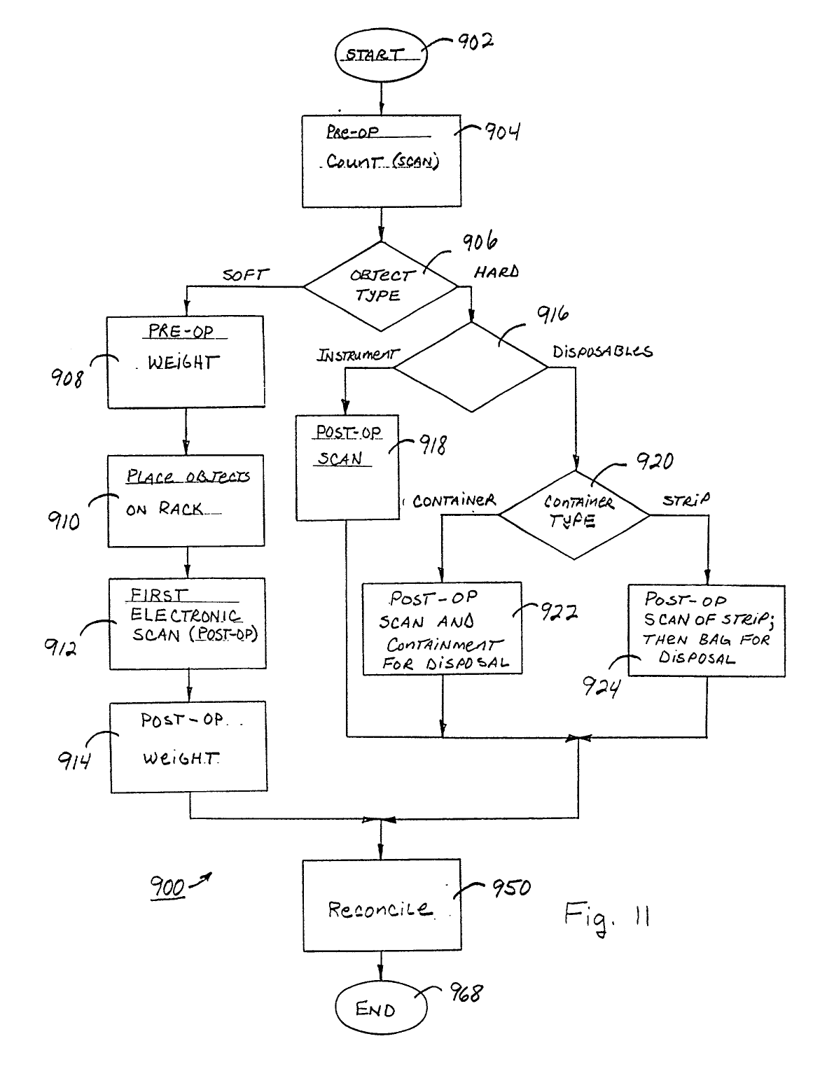

As shown in FIGS. 7 and 8, individual sharp objects such as needles 702 and scalpel blades 802 may be positioned on trays 700 and 800 for scanning prior to disposal. Trays 700 and 800 may then be scanned either by scanning device 500 or by a conventional hand-held laser scanner. Similarly, used soft objects such as lap pads, sponges and cottonoids may also be positioned on disposable holders for scanning prior to disposal. In both cases, disposal is accomplished using established methods for biological waste.

Continuing with FIGS. 9 and 10, soft objects such as lap pads, sponges and cottonoids may be positioned on a flexible storage strip 810 for counting. In FIG. 9, a number of lap pads 812-822 are positioned on storage strip 810 using the “tails” 824-834 of each pad. Each of the tails 824-834 is typically designed to be radio-opaque so that they are visible under x-ray or similar scanning device.

FIG. 10 shows a side view of lap pad 812 as it is secured to storage strip 810 by tail 824. Storage strip 810 is bowed to provide tension to tail 824 and to thus make scanning easier.

Referring now to FIG. 11, a flowchart 900 showing the steps of a method for providing inventory control of medical objects, in accordance with the preferred embodiments of the present invention, is shown. The method shown in FIG. 11 is preferably performed using apparatus 100 shown in FIG. 1 and one or more of devices 300, 400, 500 or other appropriate scanning devices.

Processing begins with step 902 and continues with step 904 in which a first pre-operative count of each object to be taken into the operating room is performed. The first pre-operative count is preferably performed by the scrub and circulating nurses using scanning devices such as transducers 114-122, a hand-held laser scanning device or other suitable scanning devices to establish an initial count, and possibly identification, for each object to be taken into the operating room. As mentioned previously, the signals generated by the scanning devices include an indicator that a pre-operative count or a post-operative count is being performed. This information can be incorporated in the signals using appropriate software and hardware in the computer system 103 and/or scanning devices. Processing continues with step 906 where the soft objects, such as lap pads and sponges, are preferably separated from the hard objects, such as instruments, needles and scalpel blades.

Processing continues with step 908 in which the soft objects may be weighed to provide a basis for determining blood and other fluid loss which may occur during the surgical procedure. During and after the surgical procedure, processing continues with step 910 in which the soft objects are placed on disposable racks for the first post-operative count. The first postoperative count is performed at step 912 using a first electronic scanning device (which may be the same device as used for the pre-operative count as described above or may be another suitable device such as devices 300, 400, 500). Additionally, at step 914 the post-operative weight of the soft objects may also be performed.

For the hard objects, processing during and after the surgical procedure continues at step 916 where the surgical instruments are separated from the disposable objects. For the surgical instruments, processing continues at step 918 in which the instruments are electronically counted by device 300, 400, 500 or some other suitable scanning device. For the disposable objects, processing continues at step 920 in which the objects are further separated into those which are stored in disposable containers and those which are lined up on trays for counting. For the objects that are stored in disposable containers, processing continues at step 922 in which each object is scanned as it is placed in the container. For objects which are lined up on trays for counting, processing continues at step 924 in which the objects are lined up on the trays and then counted by scanning such objects using one of the scanning instruments mentioned above.

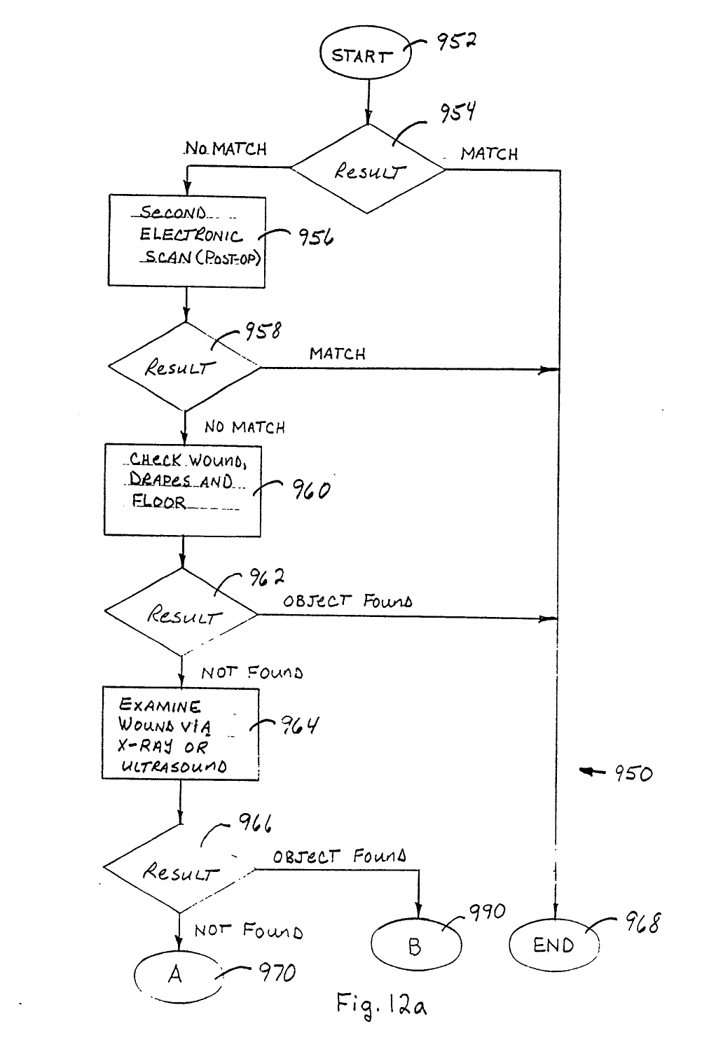

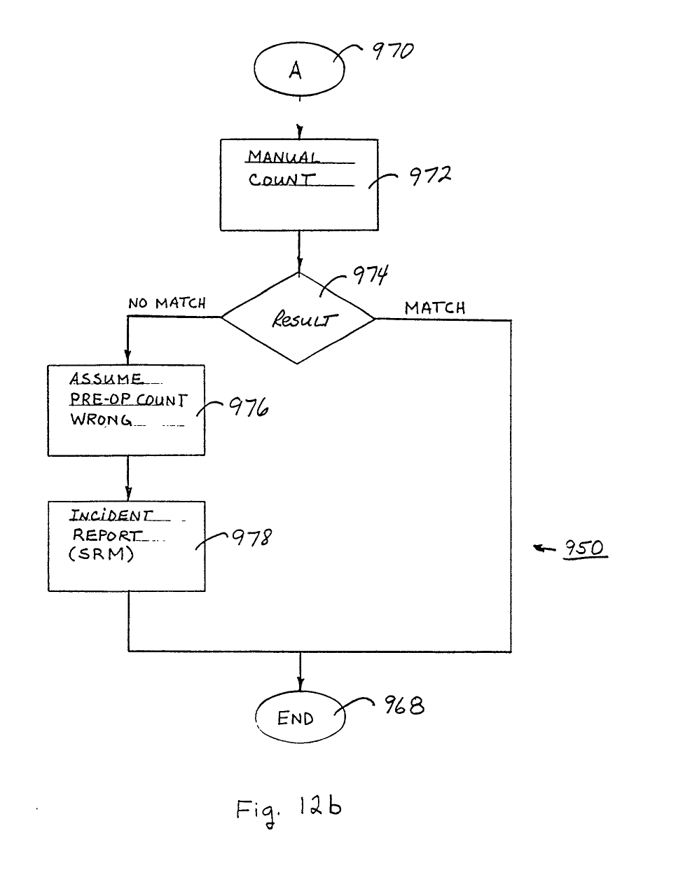

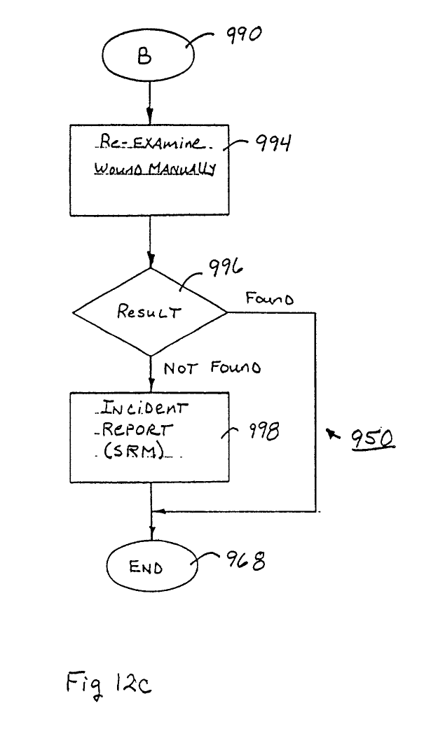

For all objects, processing continues at step 950 in which the pre-operative and post-operative counts are reconciled, which process is described in more detail with reference to FIGS. 12A-12C in the following paragraphs.

Processing then ends at step 968.

Referring to FIGS. 12a-c, a flowchart 950 showing the reconciliation of the pre-operative and post-operative counts is shown. Processing begins at step 952 and continues at step 954 in which a comparison of the preoperative and post-operative counts is made. If the counts match, processing ends at step 968. If the counts do not match, processing continues at step 956 in which a second post-operative count is performed using a second electronic scanning device, the latter which is preferably different from the scanning device used in steps 912, 922 and 924.

Processing then continues at step 958 in which the results of the second count and the pre-operative count are compared. If the counts match, processing ends at step 968. If the counts do not match, processing continues at step 960 in which a search of the wound and operating room is performed.

Processing then continues at step 962 in which the results of the search and the pre-operative count are compared. If the counts match, processing ends at step 968. If the counts do not match, processing continues at step 964 in which a radiological or ultrasound examination of the wound is performed.

Processing then continues at step 966 in which a determination of the results of the radiological or ultrasound examination of the wound is made. If the missing object has been found, processing continues at step 990. If the object has not been found, processing continues at step 970.

If the missing object has not been found during the radiological or ultrasound examination, processing then continues at step 972 (FIG. 12b) in which a manual count of the medical objects is performed. Processing continues at step 974 in which the results of the manual count and the pre-operative count are compared. If the counts match, processing ends at step 968. If the counts do not match, processing continues at step 976 in which the pre-operative count is assumed to have been in error.

Processing continues at step 978 in which an incident report regarding the error is documented. Processing then ends at step 968.

If the missing object has been found during the radiological or ultrasound examination, processing then continues at step 994 (FIG. 12c) in which the wound is manually re-explored for the purpose of retrieving the object. Processing continues at step 996 in which the results of the manual re-examination are determined. If the missing object has been found, processing ends at step 968. If the missing object has not been found, processing continues at step 998 in which an incident report documenting the type and location is prepared. Processing then ends at step 968.

In the foregoing description of the method shown in FIGS. 11-12C, it is possible to not only compare pre-operative and post-operative counts of objects, it is also possible to receive, store and compare detailed information regarding the number and types of objects used during the surgical procedure. This information can be used to readily identify an object that has not been accounted for during the post-operative inventory scanning procedure. In addition, the detailed information regarding the number and types of objects used during the surgical procedure can also be used in appropriate inventory control, materials requisition planning or similar systems.

In order to implement this preferred embodiment, the scanning devices capable of reading bar code or other printed indicia described with reference to FIGS. 4-6 and other known optical character recognition devices are preferably used. The objects to be used during the surgical procedure are scanned to generate information regarding the pre-operative count and also pre-operative inventory of objects to be used, including detailed information regarding the identity and type of each object scanned. This operation may be performed at step 904 as shown in FIG. 11.

During the surgical procedure, as objects are discarded into containers such as that shown in FIG. 4, the count and detailed information regarding the type of object being discarded is read by the device 400 and transmitted to the computer system 103. A similar post-operative scanning is done of materials which are not discarded into containers such as those in FIG. 4. Such post-operative scanning is conducted at step 924 in FIG. 11.

During the step 950 in FIG. 11 of reconciling the pre-operative and post-operative counts, in this preferred embodiment, if the pre-operative and post-operative counts do not match, the CPU 104 and appropriate known inventory software compares the detailed information regarding the number and types of objects scanned during the pre-operative scan and during the post-operative scan to readily identify the exact type and number of object or objects which are missing after the post-operative scan. Thus, this provides the surgical team with detailed information regarding the exact type and number of objects which may be missing or were incorrectly scanned.

In each of the steps of reconciling the pre-operative and postoperative scanning processes, the computer system 103 may be programmed to provide an alarm or indication, either visual, audio or otherwise, to indicate that there is no match between the post-operative and pre-operative scan and to provide detailed information about the number, type and identity of the missing objects. After such indication, the processing as shown in FIGS. 11-12C may continue until either a match occurs or an incident report is generated.

The combination of apparatus 100, one or more of devices 300, 400, 500 or other scanning devices and the method represented by flowchart 900 thus comprise a complete computer-based inventory and data collection system. The data collection system helps to insure that all objects which enter the sterile operating room environment are accounted for in the initial and final counts. The data collection system also minimizes the handling of sharp objects by eliminating most of the manual interim counts. Accordingly, the number of accidental cuts or sticks and the time spent searching for lost objects is significantly reduced. Moreover, the costs involved in extra anesthesia and operating room time can also be reduced, along with the time and expense of additional radiological studies used to determine the presence or absence of objects left in the wound. Finally, the method represented by flowchart 900 may form a component of a larger system for standardizing and controlling surgical and operating room procedures.

The foregoing description includes what are at present considered to be preferred embodiments of the invention. However, it will be readily apparent to those skilled in the art that various changes and modifications may be made to the preferred embodiments without departing from the spirit and scope of the invention. Accordingly, it is intended that such changes and modifications fall within the spirit and scope of the invention, and that the invention be limited only by the following claims.

What is claimed is:

1. An apparatus for providing inventory control of medical objects, said apparatus comprising:
a scanner for scanning each of said medical objects before and after a surgical procedure and generating a signal each time one of said medical objects is scanned;
a counter for receiving said signal from said scanning device and determining a first count of said medical objects before said surgical procedure and a second count of said medical objects after said surgical procedure; and
a reconciling device for receiving said first and second counts from said counter and for comparing said first count and said second count to determine if said first count equals said second count.

2. The apparatus of claim 1, wherein said scanner includes a reader for reading identification data contained on said medical objects.

3. The apparatus of claim 2, further comprising an identification device for receiving said identification data from said scanner and for identifying an object type of each of said medical objects scanned by said scanner, said reconciling device receiving said identification data from said identification device and matching identification data received during said first and second counts to identify a type of one of said medical objects that was identified during said first count but was not identified during said second count.

4. The apparatus of claim 1, wherein said scanner comprises at least one of a laser scanning device, an optical bar code reading device, an optical character reading device, a hand held laser scanning device, a radiological scanning device and a magnetic scanning device.

5. The apparatus of claim 1, wherein said counter and said reconciling device comprise a computer system including a memory for storing said first and second counts.

6. The apparatus of claim 1, further comprising a container for storing said medical objects after use, said container having an opening for receiving said medical objects and at least one sensor for sensing said medical objects upon insertion into said container, said at least one sensor display mechanism being removably coupled to said opening of said container.

7. The apparatus of claim 6, wherein said container further comprises an internal counter connected to said sensor for counting said medical objects received in said container.

8. The apparatus of claim 7, wherein said internal counter is connected to said counter for transmitting count information to said counter.

9. The apparatus of claim 6, wherein said container includes an alarm mechanism connected to said at least one sensor for indicating when said at least one sensor senses one of said medical objects.

10. The apparatus of claim 6, wherein said container comprises a disposable jar for storing sharp objects including needles and scalpel blades and a light emitting diode display for providing a visual count of said medical objects.

11. An apparatus for providing inventory control of medical objects, said apparatus comprising:
a container for storing said medical objects after use of said medical objects, said container having an opening for receiving said medical objects;
a counter for counting said medical objects upon insertion into said container, said counter being removably coupled to said opening of said container; and
a display connected to said counter for displaying a count of said medical objects determined by said counter.

12. The apparatus of claim 11, further comprising a reconciling device for receiving said count of said medical objects from said counter and for comparing said count of said medical objects with another count of said medical objects prior to use of said medical objects.

13. The apparatus of claim 12, wherein said reconciling device comprises a computer system including a memory for storing said counts.

14. The apparatus of claim 11, wherein said counter comprises at least one of a laser scanning device, an optical bar code reading device, an optical character reading device, a radiological scanning device and a magnetic scanning device.

15. An apparatus for providing inventory control of absorbent medical objects, said absorbent medical objects including sponges and lap pads, said apparatus comprising:
a rack for storing said absorbent medical objects after use, said rack having at least one slot for holding said absorbent medical objects;
a scale for determining an amount of blood contained in said absorbent medical objects after use;
a scanner for scanning said absorbent medical objects contained on said rack and for counting said absorbent medical objects scanned by said scanner; and
a computer system for maintaining a record of said absorbent medical objects, said computer system connected to said scanner and said scale for receiving information regarding said amount of blood contained in said absorbent medical objects and a number of said absorbent medical objects scanned by said scanner.

16. The apparatus of claim 1 5, wherein said scanner further comprises a light emitting diode display for providing a visual count of said absorbent medical objects.

17. A method for providing inventory control of medical objects used in a surgical procedure, said method comprising the steps of:
scanning and counting each of said medical objects before the surgical procedure to obtain a pre-operative count of said medical objects;
transmitting said pre-operative count to a computer system for storing said pre-operative count;
scanning and counting each of said medical objects after the surgical procedure to obtain a post-operative count of said medical objects;
transmitting said post-operative count to the computer system for storing said post-operative count; and
comparing said pre-operative count with said post-operative count for determining which of said medical objects are missing after said surgical procedure.

18. The method of claim 17, wherein said steps of scanning and counting each of said medical objects before and after the surgical procedure includes the step of reading identification information contained on each of said medical objects.

19. The method of claim 17, wherein said step of comparing said pre-operative count with said post-operative count further comprises the step of providing notification of the results of said step of comparing.

20. The method of claim 16, further comprising the steps of:
pre-operatively weighing said medical objects to obtain a pre-operative weight;
post-operatively weighing said medical objects to obtain a post-operative weight; and
comparing said pre-operative weight with said post-operative weight for determining an amount of blood lost during said surgical procedure.
